(19) United States
(12) Patent Application Publication
(10) Pub. No.: US 2009/0028444 A1
(43) Pub. Date: Jan. 29, 2009

(54) Method, medium, and apparatus with object descriptor generation using curvature gabor filter

(75) Inventors: Won-Jun Hwang, Seoul (KR); Xiangsheng Huang, Beijing (CN); Seok-cheol Kee, Ulwang-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/002,764

(22) Filed: Dec. 19, 2007

(30) Foreign Application Priority Data
Jul. 10, 2007 (KR) 10-2007-0069352

(51) Int. Cl. G06K 9/62

(52) U.S. Cl. 382/224

(57) ABSTRACT

A method, medium, and apparatus with a generated object descriptor using a curvature gabor filter, with complementary object recognition being performed by applying a general gabor filter and a curvature gabor filter having various curvatures, such that the dimension and efficiency of a feature vector can be increased by detecting correlations between features of an object searching for a parameter and its position of an optimal curvature gabor filter through boosting learning, and projecting the extracted features onto a base vector having the highest classification rate.

### CROSS-REFERENCE TO RELATED APPLICATIONS

This application claims the benefit of Korean Patent Application No. 10-2007-0069352, filed on Jul. 10, 2007, in the Korean Intellectual Property Office, the disclosure of which is incorporated herein in its entirety by reference.

### BACKGROUND

1. Field

One or more embodiments of the present invention relate to object recognition, and more particularly, to a method, medium, and apparatus generating an object descriptor using a curvature gabor filter.

2. Description of the Related Art

Due to the prevalence of terrorism and information theft nowadays, the importance of security using face recognition is gradually increasing. Accordingly, an organism recognition solution can be used as a countermeasure against the possibility of terrorism. To implement such a solution, effective techniques of counteracting terrorism include reinforcing border security and identity verification. With this in mind, the International Civil Aviation Organization (ICAO) has also recommended that biometric information be used by a machine-readable travel document reader. Likewise, the Enhanced Border Security and Visa Entry Reform Act of the U.S. provides for an introduction level of biometric identifiers and associated software and mandates the use of biometrics in travel documents, passports, and U.S. visas. Thus, biometric passports have been adopted by several nations, such as some European countries, the United States, and Japan. In addition, a new type of biometric passport having a chip with users' biometric information has also been used.

Nowadays, many agencies, companies, and other types of organizations demand that their employees and/or visitors use admission cards for identifying individuals, and accordingly, each employee or visitor must always carry a key card or a key pad for use with a card reader when he or she stays in an allowed area.

However, in this case, if a key card is lost or a key pad is stolen, security problems may occur; for example, a non-authorized person may gain access to a restricted area. As a technique of solving these security problems, biometric systems automatically recognizing and verifying personal identities using human biometric information have been developed. Such biometric systems have been used in banks, airports, and other high-security facilities, and simpler and more reliable biometric systems have also been developed.

Personal features used by such biometric systems include fingerprints, face shape, palm print, hand shape, heat image, voice, signature, venous shape, typing keystroke dynamics, retina, iris, etc. Face recognition, which is the most frequently used personal identification technique, confirms a personal identity from a plurality of faces existing in a still image or a video clip using a facial database. Since facial image data considerably varies depending on poses or illumination, it is not easy to classify various pieces of pose data of the same person to the same class.

Various image processing techniques of reducing such errors in face recognition have been suggested; however, these techniques result in errors due to assumption of linear distribution and assumption of Gaussian distributions when attempting to recognize a face.

In particular, a gabor wavelet filter has been used in face recognition and is comparatively appropriate as a technique of sensing various changes, such as an expression change and an illumination change in a facial image; however, since complex calculation processes must be performed when corresponding face recognition is performed using the gabor wavelet characteristics, parameters of the gabor wavelet filter are restrictive. The use of a gabor wavelet filter having these restrictive characteristics also increases the error occurrence probability in face recognition and does not increase the recognition rate in the face recognition, and in particular, decreases face recognition efficiency when expression changes and an illumination changes in a facial image are significant.

In order to reduce this complexity, “Face recognition by elastic bunch graph matching”, by Wiskott, L., Fellous, J.-M., Kuiger, N., and von der Malsburg, C. Pattern (Analysis and Machine Intelligence, IEEE Transactions on Volume 19, Issue 7, Jul. 1997 Page(s): 775-779) sets forth an analyzing of features by defining a filter application range as important portions of a facial image, e.g. eyes, nose, and mouth, with the same gabor filter parameters.

However, since these previously defined filter application positions are artificially defined by a user, when important points are not easily found, e.g., when there is an illumination or pose change, filter performance cannot be not guaranteed, and important points, which cannot be sensed by human intuition, may be missed.

In addition, “Boosting Local Feature Based Classifiers for Face Recognition,” by L. Zhang, S. Z. Li, Z. Qu, and X. Huang, (Conference on Computer Vision and Pattern Recognition Workshop (CVPRW'04) Volume 5, 2004) sets forth a technique of selecting features using a boosting theory.

However, according to this technique, filter application positions are statistically set with fixed filter parameters. That is, the conventional techniques described are limited in that recognition performance improvement is achieved according to filter application positions rather than parameters of a gabor filter.

In addition, Korean Patent Application No. 2006-0110170 also sets forth a technique of extending parameters of a gabor filter and selecting extended features using the boosting theory. This technique extends image analysis information by extending magnitude and angle related parameters of a gabor filter as compared to the aforementioned conventional techniques and finds an optimal set of extended features using the boosting theory. In addition, this technique causes comparatively stable recognition performance by projecting these found features using an optimal base vector for easy classification.

However, since general objects or facial images are composed of curvature components instead of linear components, the objects or facial images cannot be analyzed well using only such a conventional gabor filter.

### SUMMARY

One or more embodiments of the present invention provides a method, medium, and apparatus generating an object descriptor, whereby complementary object recognition can be performed by applying a typical gabor filter and a curvature filter having various curvatures by using a curvature gabor filter having a controllable curvature.

One or more embodiments of the present invention also provides a method, medium, and apparatus generating an object descriptor for increasing a dimension and efficiency of a feature vector by detecting correlations between features of an object, searching for a parameter and position of an optimal curvature gabor filter through boosting learning, and projecting extracted features onto a base vector having the highest classification rate.

Additional aspects and/or advantages will be set forth in part in the description which follows and, in part, will be apparent from the description, or may be learned by practice of the invention.

According to an aspect of the present invention, there is provided a method of generating an object descriptor, the method including extracting gabor features from an input object image by applying a predetermined curvature gabor filter to the object image, and generating an object descriptor for object recognition by projecting the extracted gabor features onto a predetermined base vector.

According to another aspect of the present invention, there is provided a method of generating an object descriptor, the method including extracting first gabor features from a training object image by applying a curvature gabor filter to the training object image, selecting gabor features by performing boosting learning for object image classification with respect to the extracted gabor features and establishing a gabor feature set comprising the selected gabor features, generating a base vector by performing linear determination analysis of the established gabor feature set, extracting second gabor features from an input object image by applying a curvature gabor filter having the established gabor feature set to the input object image, and generating an object descriptor for object recognition by projecting the extracted second gabor features onto the generated base vector.

According to another aspect of the present invention, there is provided an apparatus for generating an object descriptor, the apparatus including a first feature extractor extracting gabor features from an input object image by applying a predetermined curvature gabor filter to the object image, and an object descriptor generator generating an object descriptor for object recognition by projecting the extracted gabor features onto a predetermined base vector.

According to another aspect of the present invention, there is provided a computer readable recording medium storing a computer readable program for executing the methods.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an object descriptor generating apparatus, according to an embodiment of the present invention;

FIGS. 2A and 2B are diagrams describing a characteristic of a curvature gabor filter, according to an embodiment of the present invention;

FIGS. 3A to 3C are diagrams describing curvature gabor filters having various curvatures, according to an embodiment of the present invention;

FIGS. 4A and 4B are diagrams obtained by applying a conventional gabor filter to a facial image and by applying curvature gabor filters, according to an embodiment of the present invention, to a facial image, respectively.

FIG. 5 illustrates a method of generating an object descriptor, according to an embodiment of the present invention;

FIG. 6 illustrates an object recognition apparatus using an object descriptor generating apparatus, such as that of FIG. 1, according to an embodiment of the present invention; and

FIG. 7 illustrates a method of generating an object descriptor using filters having various curvatures, according to an embodiment of the present invention.

### DETAILED DESCRIPTION OF THE EMBODIMENTS

Reference will now be made in detail to embodiments, examples of which are illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

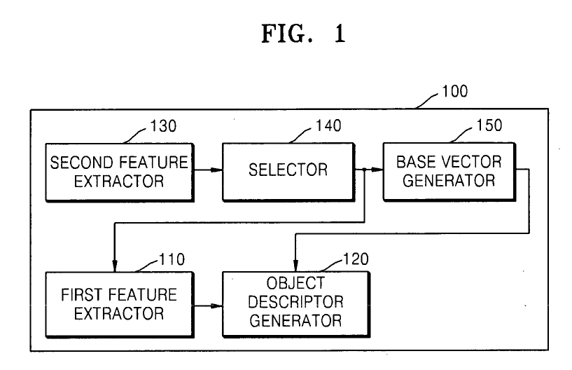

FIG. 1 illustrates an object descriptor generating apparatus 100, according to an embodiment of the present invention. Herein, the term apparatus should be considered synonymous with the term system, and not limited to a single enclosure or all described elements embodied in single respective enclosures in all embodiments, but rather, depending on embodiment, is open to being embodied together or separately in differing enclosures and/or locations through differing elements, e.g., a respective apparatus/system could be a single processing element or implemented through a distributed network, noting that additional and alternative embodiments are equally available.

Referring to FIG. 1, the object descriptor generating apparatus 100, according to an embodiment of the present invention, may include a first feature extractor 110, an object descriptor generator 120, a second feature extractor 130, a selector 140, and a base vector generator 150, for example. The first feature extractor 110 and the object descriptor generator 120 may be components for generating an object descriptor with respect to an input object image, and the second feature extractor 130, the selector 140, and the base vector generator 150 may be components for learning an object image stored in a predetermined database, for example, noting that alternatives are also available. Here, in this example, the components for learning may act to find an optimal set of curvature gabor filters and generate a base vector having a good classification rate of features found from the optimal set, and the components for generating an object descriptor may act to generate an object descriptor for describing an input object image by extracting features from the input object image using parameters and positions of optimal curvature gabor filters found by the components for learning and by projecting the extracted features on the base vector generated by the components for learning.

Although not illustrated in FIG. 1, in an embodiment, the object descriptor generating apparatus 100 may further include an object image database, an image pre-processor, and an input image acquisitor, for example. The object image database may store images for object recognition or identity identification, for example, and store information on a plurality of facial images having various facial expressions, angles, and brightness values in order to increase face recognition efficiency in the case of face recognition. The image pre-processor may perform predetermined pre-processing of an input object image or an image, for example, before it is stored in the object image database. For example, in an embodiment, the image pre-processor may remove a background portion from an input image, adjust the size of the image based on an eye position, and modify the facial image through a pre-processing process for decreasing a degree of dispersion of lighting so that the facial image is suitable for generating a face descriptor. The input image acquisitor may further acquire an input object image for object recognition, for example, and acquire an object image for object recognition or a human facial image for identity verification using a camera or a camcorder.

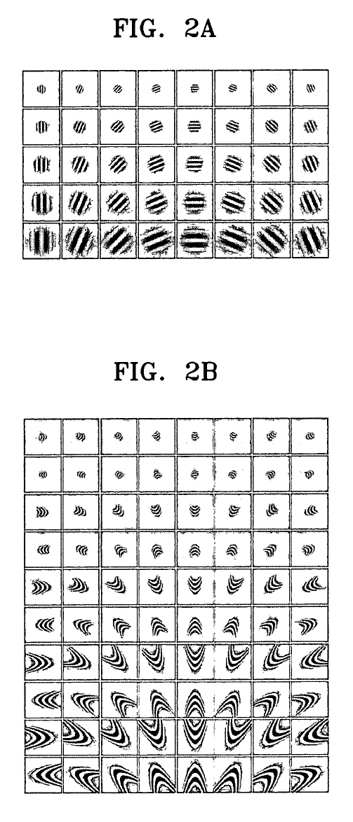

The first feature extractor 110 may, thus, extract features by applying a curvature gabor filter having various curvatures to an input object image. In this case, various curvature gabor filters, according to the curvatures, can be used. For example, features having different characteristics may be extracted by using one general gabor filter in combination with three curvature gabor filters having different curvatures, noting that alternatives are also available. Here, the first feature extractor 110 may also apply curvature gabor filters to the input object image by receiving optimal curvature gabor filter parameters extracted in a learning stage and filter application positions in the object image. The features and applications of the curvature gabor filters will be further described in greater detail below with reference to FIGS. 2 through 4.

The object descriptor generator 120 may generate an object descriptor using the gabor features received from the first feature extractor 110. In detail, in an embodiment, the object descriptor generator 120 generates an object descriptor or an object feature vector by projecting the gabor features onto a base vector having a high classification rate. The object descriptor generator 120 may also generate an object descriptor by using a base vector generated by the base vector generator 150, wherein the base vector is generated through a Linear Determination Analysis (LDA) learning, for example, of a gabor feature set generated by the selector 140.

The second feature extractor 130 may extract gabor features by applying respective curvature gabor filters to an object image, e.g., the object image stored in the object image database. Although the first and second feature extractors 110 and 130 perform different operations, as described in this embodiment, the above-described operations could be performed by a single feature extractor, for example, noting that alternatives are also available.

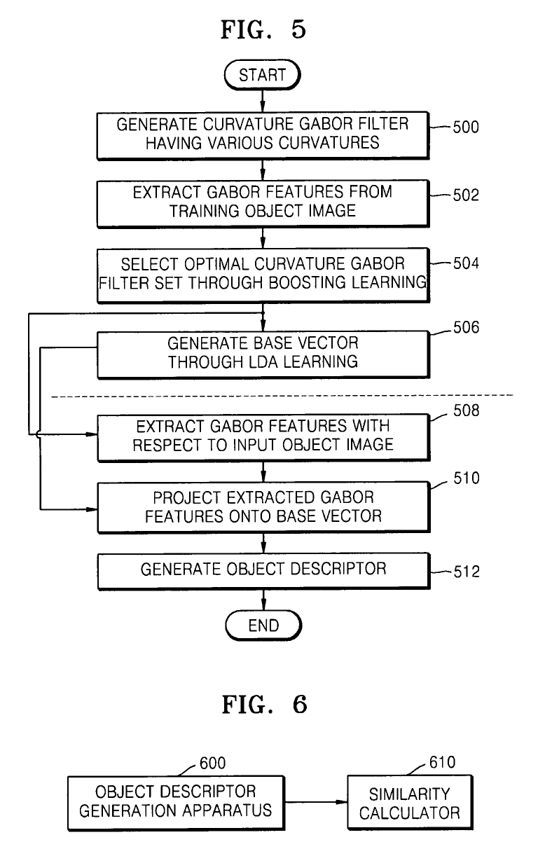

The selector 140 may select efficient gabor features by performing boosting learning, for example, on the gabor features extracted by the second feature extractor 130 and establish a gabor feature set including the selected gabor features. The gabor feature set may include a parameter and its applied position of a curvature gabor filter optimal to a specific object image. According to an embodiment, the selecting of efficient gabor features from among the gabor features extracted by the second feature extractor 130 may be performed because the number of gabor filters that could be required to be applied over all areas of an image would be too numerous. Here, for example, it should also be understood that the boosting learning could be replaced with a statistical re-sampling algorithm, again noting that alternatives are also available. According to an embodiment, this example boosting learning will be described below in greater detail with reference to FIG. 5.

The base vector generator 150 may generate a base vector, for example, by performing the LDA learning of the gabor feature set generated by the selector 140. In such an embodiment, the LDA learning may use an LDA algorithm, which will be described further below.

FIGS. 2A and 2B are diagrams describing a characteristic of a curvature gabor filter, according to an embodiment of the present invention.

According to an embodiment of the present invention, a conventional gabor filter popularly used for object or face recognition may be represented by the below Equation 1, for example.

Equation 1:

$$ψ ( \vec{x} ; v ) = \frac{{k}_{v}^{2}}{{σ}^{2}} exp ( - \frac{{k}_{v}^{2} {\vec{x}}^{2}}{2 {σ}^{2}} ) [ exp ( i {k}_{v} {x}^{′} ) - exp ( - \frac{{σ}^{2}}{2} ) ]$$

Here, kᵥ denotes the magnitude of a gabor filter, wherein

$${k}_{v} = {2}^{- \frac{v + 2}{2} π}$$

and σ=2π. In order to provide an angle to the gabor filter according to an (x, y) increase, the below Equation 2 may further be used, for example.

Equation 2:

$$\vec{x} = ( \begin{matrix}{x}^{1} \\ {y}^{′}\end{matrix} ) = ( \begin{matrix}x cos ϕ + y sin ϕ \\ - x sin ϕ + y cos ϕ\end{matrix} ) .$$

Here, an angle change according to the (x, y) increase follows

$${ϕ}_{μ} = μ \frac{π}{8} ,$$

and a total of 8 angles may be used. According to an embodiment of the present invention, by using Equations 1 and 2, for example, the conventional gabor filter may be further represented by the below Equation 3, for example.

Equation 3:

$$ψ ( x , y ; v , μ ) = \frac{{k}_{v}^{2}}{{σ}^{2}} exp ( - \frac{{k}_{v}^{2} ( {x}^{2} + {y}^{2} )}{2 {σ}^{2}} ) [ exp ( i {k}_{v} ( x cos {ϕ}_{μ} + y sin {ϕ}_{μ} ) ) - exp ( - \frac{{σ}^{2}}{2} ) ]$$

Thus, according to an embodiment of the present invention, a curvature gabor filter may be formed to provide a curvature to the conventional gabor filter represented by Equation 3. This curvature gabor filter may be further represented by the below Equation 4, for example, as obtained by providing a curvature to Equation 2, for example.

Equation 4:

$$\begin{matrix}\vec{x} = ( \begin{matrix}{x}^{1} \\ {y}^{′}\end{matrix} ) \\ = ( \begin{matrix}x cos ϕ + y sin ϕ + {c ( - x sin ϕ + y cos ϕ )}^{2} - \\ x sin ϕ + y cos ϕ\end{matrix} )\end{matrix}$$

Here, c denotes a curvature parameter. That is, here in this example, if the value of c increases, the curvature increases, and as the value of c decreases, the curve approaches the shape of a straight line. Finally, when c is 0, the example curvature gabor filter becomes similar to the conventional gabor filter.

By using Equations 1 through 4, the curvature gabor filter may be further defined by the below Equation 5, for example.

Equation 5:

$$ψ ( x , y ; v , μ , c ) = \frac{{k}_{v}^{2}}{{σ}^{2}} exp ( - \frac{{k}_{v}^{2}}{2 {σ}^{2}} ( {( x cos {ϕ}_{μ} + y sin {ϕ}_{μ} + {c ( - x sin {ϕ}_{μ} + y cos {ϕ}_{μ} )}^{2} )}^{2} + {( - x sin {ϕ}_{μ} + y cos {ϕ}_{μ} )}^{2} ) ) [ exp ( i {k}_{v} ( x cos {ϕ}_{μ} + y sin {ϕ}_{μ} + {c ( - x sin {ϕ}_{μ} + y cos {ϕ}_{μ} )}^{2} ) - exp ( - \frac{{σ}^{2}}{2} ) ) ]$$

Here,

$${k}_{v} = {2}^{- \frac{v + 2}{2} π} , σ = 2 π ,$$

and

$${ϕ}_{μ} = μ \frac{π}{8} ,$$

for example.

Referring to FIGS. 2A and 2B, FIG. 2A shows a real number portion of the conventional gabor filter, and FIG. 2B shows a real number portion of the curvature gabor filter according to an embodiment of the present invention. As illustrated in FIGS. 2A and 2B, while only magnitude and angle vary in the case of the conventional gabor filter, the curvature gabor filter according to this embodiment shows curved shapes.

In addition, according to an embodiment, since this curvature gabor filter can use 0° to 360°, compared to conventional gabor filters using only 0° to 180°, twice as many curvature gabor filters may now be available. Here, in the conventional gabor filters the shape of the straight filters is the same for degrees greater 180°. For example, the 30° filter is the same as the 210° filter in the conventional gabor filter, while corresponding curvature gabor filters would be different due to their curved filter shapes. An embodiment of the present invention further solves a problem of complexity in calculation, caused by the increase in the number of filters, by gabor feature selection using boosting learning, which will be described in greater detail below.

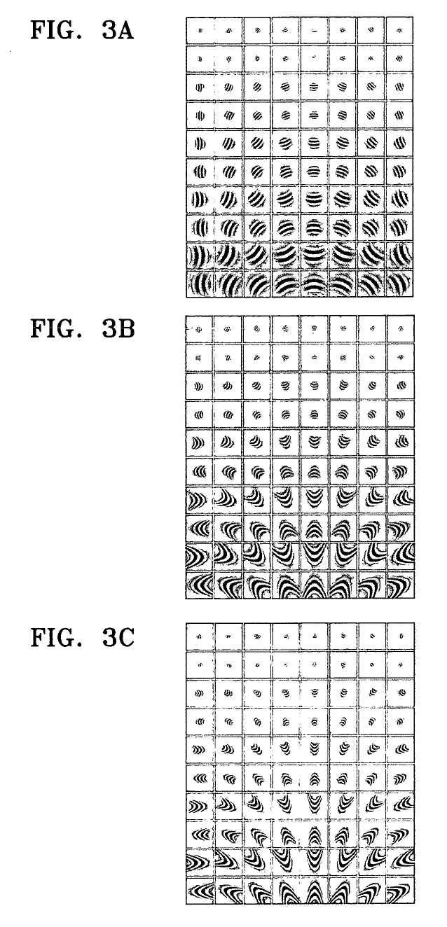

FIGS. 3A to 3C are diagrams describing curvature gabor filters having various curvatures, according to one more embodiments of the present invention.

In this embodiment, three curvature gabor filters having different curvatures are shown. FIG. 3A shows a real number portion of a curvature gabor filter having a small curvature, FIG. 3B shows a real number portion of a curvature gabor filter having an intermediate curvature, and FIG. 3C shows a real number portion of a curvature gabor filter having a large curvature. Here, though three curvature gabor filters are shown, more curvature filters with different curve ratios from the current three curvatures may also be added, e.g., for better performances.

Again, although three curvatures are illustrated in this embodiment, features of an object can be extracted using more or less curvatures.

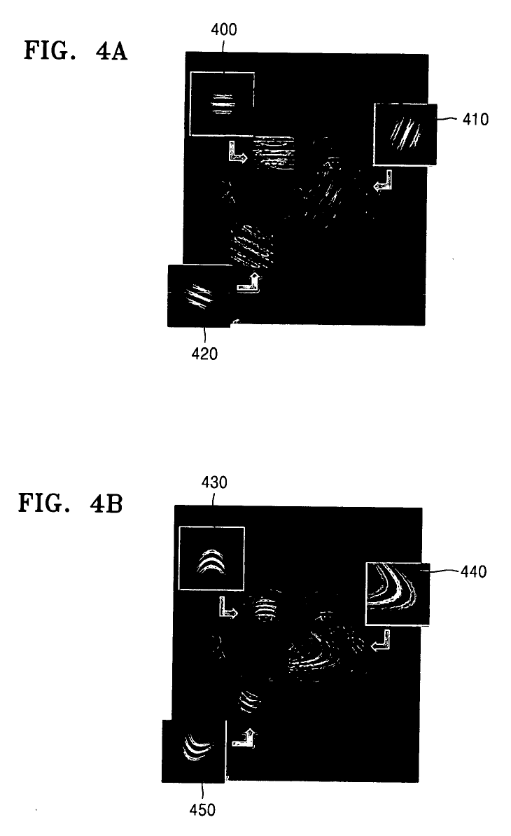

FIGS. 4A and 4B are diagrams obtained by applying a conventional gabor filter to a facial image and by applying curvature gabor filters, according to an embodiment of the present invention, to a facial image, respectively.

Referring to FIG. 4A, an eye and eyebrow portion 400 of the illustrated face are shown as being analyzed with a direct line pattern according to the conventional gabor filter, while referring to FIG. 4B, an eye and eyebrow portion 430 are shown as being analyzed with a curved pattern according to a curvature gabor filter according to the present invention. Likewise, referring to FIG. 4A, while a nose portion 410 and a chin portion 420 are shown as being analyzed with the direct line pattern according to the conventional gabor filter, referring to FIG. 4B, a nose portion 440 and a chin portion 450 are shown as being analyzed with the curved pattern according to a curvature gabor filter according to the present invention. According to embodiments of the present invention, essentially, since eyes, a nose, and a chin are formed with curved components, it has been found that a curvature gabor filter can more accurately analyze features of objects compared to conventional direct line type gabor filters.

In addition, according to an embodiment of the present invention, an object may be analyzed by both considering direct line components and curved components of an object image and respectively applying curvature gabor filters having controllable curvatures to the curved components, with optimal parameters and their positions being found and analyzed by combining the analysis result. Therefore, the performance of one or more embodiments of the present invention is greater than when only a conventional gabor filter is used. However, it is difficult to generate a base vector due to the increase in complexity of calculation caused by using twice as many filters as conventional gabor filters due to analyzing the angle change up to 360°. According to an embodiment, this problem may be solved by selecting optimal filters through the aforementioned boosting learning.

FIG. 5 illustrates a method of generating an object descriptor, according to an embodiment of the present invention.

Referring to FIG. 5, the generation of an object descriptor may be generally divided into two processes, for example, noting that alternatives are also available. Operations 500 through 506 can be considered as corresponding to a training process, wherein boosting is performed to find an optimal set of curvature gabor filters by extracting gabor features from an object image stored in a database, for example, and a base vector having a good classification rate is generated through the boosting. Operations 508 through 512 can be considered as corresponding to an object descriptor generation process, wherein an object descriptor is generated by extracting gabor features from an input object image and projecting the extracted features (feature vectors) onto the base vector. Thus, in such an embodiment, in the object descriptor generation process, features may be extracted from an input object image using optimal curvature gabor filter parameters and their positions, which are found in the training process, and an object descriptor is generated by projecting the extracted features onto the base vector generated in the training process.

Accordingly, in operation 500, a curvature gabor filter having various curvatures may be generated. Here, the curvature gabor filter may be represented by the above Equation 5, for example. Thus, in this example, the curvature of the curvature gabor filter depends on the parameter c.

In operation 502, features may be extracted by applying the curvature gabor filter generated in operation 500 to a training object image, for example. In operation 504, an optimal curvature gabor filter set may further be selected by performing the above example boosting learning with respect to the features extracted in operation 502. As described above, the number of gabor filters required to be applied over all areas of an object image may be too numerous. For example, when gabor filters are applied to a gray image having a size of 46×56 pixels, the number of conventional gabor filters may be 46×56×40, and the number of curvature gabor filters may be doubled to 46×56×80. Thus, when too many features are extracted, since it is difficult to generate an optimal LDA base vector by comparing correlations between them, an optimal filter set may found through adaboost, according to an embodiment of the present invention. In this case, a conventional boosting learning method such as GentleBoost, realBoost, KLBoost, or JSBoost may be used, noting that alternatives are also available. According to an embodiment, object image recognition efficiency may be increased by selecting complementary gabor features from sub-sets using the boosting learning.

In an embodiment, the boosting learning may be performed under the assumption that one gabor filter, i.e., one parameter and its position, is used. Since an adaboost algorithm is known, a further detailed description thereof will not be provided. Such an adaboost algorithm is as follows:

begin initialize D = {x¹, y₁, . . . , xⁿ, yₙ}, W₁(i) = 1/n, i = 1, . . . , n
k ← 0
do k ← k + 1

train weak learner Cₖ using D sampled according to Wₖ(i)
Eₖ < training error of Cₖ measured on D using Wₖ(i)
${a}_{k} ← \frac{1}{2} ln [ ( 1 - {E}_{k} ) / {E}_{k} ]$ ${W}_{k + 1} ( i ) ← \frac{{W}_{k} ( i )}{{Z}_{k}} \times \{ \begin{matrix}{e}^{- {a}_{k}} {ifh}_{k} ( {x}^{i} ) = {y}_{i} ( correctlyclassified ) \\ {e}^{{a}_{k}} {ifh}_{k} ( {x}^{i} ) \neq {y}_{i} ( in correctlyclassified )\end{matrix}$
until k = kₘₐₓ

return Cₖ and aₖ for k = 1 to kₘₐₓ (ensemble of classifiers with weights)
end

This selected gabor filter set M={(m, n)|selected features by boosting} may be represented by the below Equation 6, for example, with the position and parameter.

Equation 6:

y_{m,n}=r(x,y)+ji(x,y)

=I(X+m,y+n)·ψ(x,y;v,μ,c) . . . 0≦x,y≦G

Here, G denotes the magnitude of a gabor filter. An applied value of the gabor filter can be divided into a real number portion and an imaginary number portion, and magnitude information and phase information may be extracted, such as by using the below Equation 7, for example.

Equation 7:

$$mag ( x , y ) = \sqrt{{r ( x , y )}^{2} + {i ( x , y )}^{2}}$$

$$pha ( x , y ) = {tan}^{- 1} \frac{r ( x , y )}{i ( x , y )}$$

This extracted magnitude and phase information may be used as a feature vector of an object, and since the magnitude can robustly withstand image transformation, the magnitude information may be used. In addition, since the phase information shows complementary features with the magnitude, the phase information may be selectively used with the magnitude information.

In operation 506, a base vector may be generated through the example LDA learning using the selected gabor filter set. That is, a feature vector generated using Equations 6 and 7, for example, may be projected onto a base vector optimizing classification. The LDA technique is a technique of linearly projecting data onto a sub-space reducing within-class scatter and maximizing between-class scatter. Here, the LDA base vector generated in operation 506 is a representative value, which can represent a characteristic of a set of interest in object recognition and be efficiently used for object recognition of the set, and can be calculated through the process described below.

Here, LDA may use a ratio of a Within Scatter Matrix S_{W} and a Between Scatter Matrix S_{B}, which may be represented by the below Equation 8, for example.

$${S}_{W} = {\sum }_{i = 1}^{m} {\sum }_{x ∈ {X}_{i}} ( x - {\overline{x}}_{i} ) {( x - {\overline{x}}_{i} )}^{T}$$

$${S}_{B} = {\sum }_{i = 1}^{m} {N}_{i} ( {\overline{x}}_{i} - \overline{x} ) {( {\overline{x}}_{i} - \overline{x} )}^{T}$$

From these calculated scatter matrices, a base vector, by which dispersion of the Within Scatter Matrix S_{W} is minimized and dispersion of the Between Scatter Matrix S_{B} is maximized, may be generated using the below Equation 9, for example.

$${Φ}_{opt} = arg {max}_{Φ} \frac{\vert {Φ}^{T} {S}_{B} Φ \vert}{\vert {Φ}^{T} {S}_{W} Φ \vert} = [ {φ}_{1} {φ}_{2} … {φ}_{k} ]$$

Here, Φₒₚₜ denotes a base vector.

In operation 508, gabor features with respect to an input object image may then be extracted. Here, the gabor features may be extracted by using the parameter and position of the curvature gabor filter selected in operation 504, for example. In operation 510, the extracted features (feature vectors) are projected onto a base vector. The extracted features may be projected onto the base vector generated in operation 506. In operation 512, an object descriptor may then be generated. If it is assumed that the magnitude vector extracted from Equation 7 is m, the vector projection expression, Equation 10 below, may be used, for example.

Equation 10:

y=Φ^{T}(m−mₘₑₐₙ)

Here, the vector y becomes the final feature of the object, and this feature vector can act as a general gabor feature vector or a curvature gabor feature vector because the filter operation can be controlled to act as the general gabor filter or the curvature gabor filter based on the setting of the filter parameter c This projected vector y is a final object descriptor.

FIG. 6 illustrates an object recognition apparatus with an object descriptor generating apparatus, such as that of FIG. 1, according to an embodiment of the present invention.

Referring to FIG. 6, the object recognition apparatus may include an object descriptor generation apparatus 600 and a similarity calculator 610, for example. According to an embodiment of the present invention, the object descriptor generation apparatus 600 may generate an object descriptor according to the object descriptor generation method described with reference to FIG. 5, for example, and may provide the generated object descriptor to the similarity calculator 610. Here, the similarity calculator 610 may further calculate similarity with a feature vector of an arbitrary target image using the object descriptor Y generated using Equation 10, for example, and determine that the two objects are the same, i.e., sufficiently similar.

Here, in this embodiment, the similarity calculation may be performed using Weighted Normalized Correlation, such as in the below Equation 11, for example.

Equation 11:

$${Y}_{i} = ⌊ {y}_{ig} , {y}_{{ib}_{1}} , {y}_{{ib}_{2}} , {y}_{{ib}_{3}} ⌋$$

$$S ( {Y}_{i} , {Y}_{j} ) = {w}_{1} \frac{{y}_{ig} \cdot {y}_{jg}}{‖ {y}_{ig} ‖ \cdot ‖ {y}_{jg} ‖} + {\sum }_{k = 2}^{4} {w}_{k} \cdot ( \frac{{y}_{{ib}_{k}} \cdot {y}_{{jb}_{k}}}{‖ {y}_{{ib}_{k}} ‖ \cdot ‖ {y}_{{jb}_{k}} ‖} )$$

$$… {\sum }_{k = 1}^{4} {w}_{k} = 1$$

In an embodiment, this obtained similarity may have a value between −4 and 4, wherein an input object having been determined to be different from another object may be represented by the similarity having a value of −4, and the input object having been determined to be fully identical to the other object may be represented by the similarity having a value of 4. In addition, in an embodiment, a specific threshold may be set and an input object may be determined to be recognized as the same as the other object when the similarity has a value greater than the specific threshold.

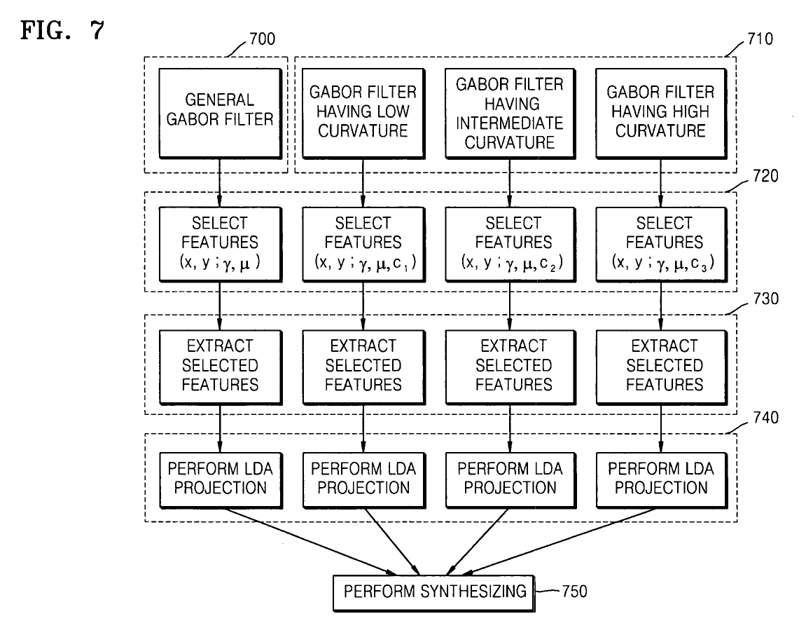

FIG. 7 illustrates a method of generating an object descriptor using a conventional gabor filter and gabor filters having various curvatures, according to an embodiment of the present invention.

Referring to FIG. 7, the conventional gabor filter and gabor filters having various curvatures may be generated in operations 700 and 710, and gabor features may be extracted from a training object image by applying the gabor filters to the training object image.

Feature sets including optimal positions and filter parameters may then be selected through the boosting learning in operation 720. Here, in an embodiment, a feature set (x, y; v, μ) of the conventional gabor filter, a feature set (x, y; v, μ, c₁) of a gabor filter having a low curvature, a feature set (x, y; v, μ, c₂) of a gabor filter having an intermediate curvature, and a feature set (x, y; v, μ, c₃) of a gabor filter having a high curvature may be selected, wherein c₁<c₂<c₃, noting that alternatives are also available.

Gabor features selected by applying the selected feature sets to an input object image may be extracted in operation 730. Each of the extracted gabor features may further be projected onto a base vector generated through the LDA learning in operation 740, and an object descriptor generated by synthesizing the projection results in operation 750.

In addition to the above described embodiments, embodiments of the present invention can also be implemented through computer readable code/instructions, i.e., as a computer program, in/on a medium, i.e., a computer readable recording medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as media carrying or including carrier waves, as well as elements of the Internet, for example. Thus, the medium may be such a defined and measurable structure including or carrying a signal or information, such as a device carrying a bitstream, for example, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As described above, according to one or more embodiments of the present invention, complementary object recognition can be performed by applying not only a conventional gabor filter but also a curvature gabor filter having various curvatures, for example, and the dimension and efficiency of a feature vector may be increased by detecting correlations between features of an object searching for a parameter and its position of an optimal curvature gabor filter through boosting learning, and projecting the extracted features onto a base vector having the highest classification rate.

While this invention has been particularly shown and described with reference to particular example embodiments thereof, it will be understood by those of ordinary skill in the art that various changes in form and details may be made therein without departing from the spirit and scope of the invention. The particular example embodiments should be considered in descriptive sense only and not for purposes of limitation.

Thus, although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of generating an object descriptor, the method comprising:
extracting gabor features from an input object image by applying a predetermined curvature gabor filter to the object image; and
generating an object descriptor for object recognition by projecting the extracted gabor features onto a predetermined base vector.

2. The method of claim 1, further comprising:
extracting gabor features from a training object image by applying the curvature gabor filter to the training object image; and
selecting gabor features by performing boosting learning for object image classification with respect to the extracted gabor features and establishing a gabor feature set comprising the selected gabor features,
wherein the extracting of the gabor features comprises extracting gabor features by applying a curvature gabor filter having the established gabor feature set to the input object image.

3. The method of claim 2, further comprising generating a base vector by performing Linear Determination Analysis (LDA) of the established gabor feature set,
wherein the generating of the object descriptor comprises generating an object descriptor for object recognition by projecting the extracted gabor features onto the generated base vector.

4. The method of claim 1, wherein the curvature gabor filter has at least one curvature.

5. The method of claim 4, wherein the curvature gabor filter satisfies the equation below
$$ψ ( x , y ; v , μ , c ) = \frac{{k}_{v}^{2}}{{σ}^{2}} exp ( - \frac{{k}_{v}^{2}}{2 {σ}^{2}} ( {( x cos {ϕ}_{μ} + y sin {ϕ}_{μ} + {c ( - x sin {ϕ}_{μ} + y cos {ϕ}_{μ} )}^{2} )}^{2} + {( - x sin {ϕ}_{μ} + y cos {ϕ}_{μ} )}^{2} ) ) [ exp ( i {k}_{v} ( x cos {ϕ}_{μ} + y sin {ϕ}_{μ} + {c ( - x sin {ϕ}_{μ} + y cos {ϕ}_{μ} )}^{2} ) - exp ( - \frac{{σ}^{2}}{2} ) ) ]$$

6. The method of claim 2, wherein the gabor feature set comprises a parameter of the curvature gabor filter and a position of the input object image to which the curvature gabor filter is applied.

7. A method of generating an object descriptor, the method comprising:
extracting first gabor features from a training object image by applying a curvature gabor filter to the training object image;
selecting gabor features by performing boosting learning for object image classification with respect to the extracted gabor features and establishing a gabor feature set comprising the selected gabor features;
generating a base vector by performing Linear Determination Analysis (LDA) of the established gabor feature set;
extracting second gabor features from an input object image by applying a curvature gabor filter having the established gabor feature set to the input object image; and
generating an object descriptor for object recognition by projecting the extracted second gabor features onto the generated base vector.

8. A computer readable recording medium storing a computer readable program for executing the method of claim 1.

9. An apparatus for generating an object descriptor, the apparatus comprising:
a first feature extractor to extract gabor features from an input object image by applying a predetermined curvature gabor filter to the object image; and
an object descriptor generator to generate an object descriptor for object recognition by projecting the extracted gabor features onto a predetermined base vector.

10. The apparatus of claim 9, further comprising:
a second feature extractor to extract gabor features from a training object image by applying the curvature gabor filter to the training object image; and
a selector to select gabor features by performing boosting learning for object image classification with respect to the extracted gabor features and to establish a gabor feature set comprising the selected gabor features,
wherein the first feature extractor extracts gabor features by applying a curvature gabor filter having the established gabor feature set to the input object image.

11. The apparatus of claim 10, further comprising a base vector generator to generate a base vector by performing Linear Determination Analysis (LDA) of the established gabor feature set,
wherein the object descriptor generator generates an object descriptor for object recognition by projecting the gabor features extracted by the first feature extractor onto the generated base vector.

12. The apparatus of claim 9, wherein the curvature gabor filter has at least one curvature.

13. The apparatus of claim 12, wherein the curvature gabor filter satisfies the equation below
$$ψ ( x , y ; v , μ , c ) = \frac{{k}_{v}^{2}}{{σ}^{2}} exp ( - \frac{{k}_{v}^{2}}{2 {σ}^{2}} ( {( x cos {ϕ}_{μ} + y sin {ϕ}_{μ} + {c ( - x sin {ϕ}_{μ} + y cos {ϕ}_{μ} )}^{2} )}^{2} + {( - x sin {ϕ}_{μ} + y cos {ϕ}_{μ} )}^{2} ) ) [ exp ( i {k}_{v} ( x cos {ϕ}_{μ} + y sin {ϕ}_{μ} + {c ( - x sin {ϕ}_{μ} + y cos {ϕ}_{μ} )}^{2} ) - exp ( - \frac{{σ}^{2}}{2} ) ) ]$$

14. The apparatus of claim 10, wherein the gabor feature set comprises a parameter of the curvature gabor filter and a position of the input object image to which the curvature gabor filter is applied.
